(19) United States
(12) Patent Application Publication
(10) Pub. No.: US 2018/0283649 A1
(43) Pub. Date: Oct. 4, 2018

(54) LAMP

(71) Applicant: Yu-Feng CHENG, New Taipei City (TW)

(72) Inventor: Yu-Feng CHENG, New Taipei City (TW)

(21) Appl. No.: 15/475,493

(22) Filed: Mar. 31, 2017

(51) Int. Cl. F21V 1/06; F21V 23/06; F21V 23/02; F21L 4/00; F21V 9/08; F21V 17/00

(52) U.S. Cl. CPC F21V 1/06; F21V 23/06; F21V 23/02; F21Y 2115/10; F21V 9/08; F21V 17/007; F21L 4/00

(57) ABSTRACT

A lamp includes a lamp shade, a support frame and a light strip. The lamp shade is a pull string bag. The support frame is mounted inside the body of the lamp shade to prop and expand the lamp shade to define the accommodation space within the body of the lamp shade. The light strip is mounted inside the accommodation space of the lamp shade, is located within the support frame, and has a power connection terminal formed on one end of the light strip and electrically connected to an external power source. The lamp can be operated in collaboration with a mobile power pack for the lamp to be placed at anywhere to provide lighting.

### BACKGROUND OF THE INVENTION

### 1. Field of the Invention

The present invention relates to a lamp and, more particularly, to a portable lamp with low power consumption.

### 2. Description of the Related Art

Outdoor activities attract more and more people in pursuit of health. Camping and mountain climbing has become one of the recreation options for people in their leisure time during the weekend.

Under the circumstance of outdoor activities, sometimes camping outdoors becomes inevitable. There is a likelihood of no lighting arising from no access to electricity. To tackle the power issue, campers may consider carrying a power generator to generate power for lighting. However, a power generator is not an item that can be easily carried. Besides, no lighting is still a problem in the area that is out of reach of an extension cord in connection with the power generator because of no access to the power generator.

Generally, campers would bring their own camping lanterns. As long as the camping lanterns can be connected to the power generator, lighting is available from the camping lanterns. On the other hand, if used in areas out of reach of extension cables connected to the power generator, the camping lanterns fail to come in handy.

### SUMMARY OF THE INVENTION

An objective of the present invention is to provide a portable lamp with low power consumption.

To achieve the foregoing objective, the lamp includes a lamp shade, a support frame and a light strip.

The lamp shade has a body, an accommodation space, an opening, a pull string and a retainer.

The body has an open end.

The accommodation space is defined inside the body.

The opening is formed around a rim of the open end of the body and communicates with the accommodation space.

The pull string penetrates an edge portion of the open end of the body adjacent to the opening with a part of the pull string retained inside the edge portion and a remaining part of the pull string exposed.

The retainer is mounted through by the pull string and is movably attached to the pull string to adjust a size of the opening.

The support frame is mounted inside the body of the lamp shade to prop and expand the lamp shade to define the accommodation space within the body of the lamp shade.

The light strip is mounted inside the accommodation space of the lamp shade, is located within the support frame, and has a power connection terminal formed on one end of the light strip and electrically connected to an external power source.

Preferably, the external power source is a mobile power pack.

Preferably, the light strip is a light-emitting diode (LED) light strip.

The foregoing lamp is advantageous in that the light strip of the lamp is a LED light strip, which can be operated together with a mobile power pack at a low power consumption, allowing the lamp to be placed at anywhere to provide lighting.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a lamp in accordance with the present invention;

FIG. 2 is an exploded perspective view of the lamp in FIG. 1;

FIG. 3 is an operational perspective view of the lamp in FIG. 1 connected with a transformer;

FIG. 4 is an operational perspective view of the lamp in FIG. 1 connected to a mobile power pack; and

FIG. 5 is a perspective view of the lamp in FIG. 1 with a light strip wrapped by a transparent paper.

### DETAILED DESCRIPTION OF THE INVENTION

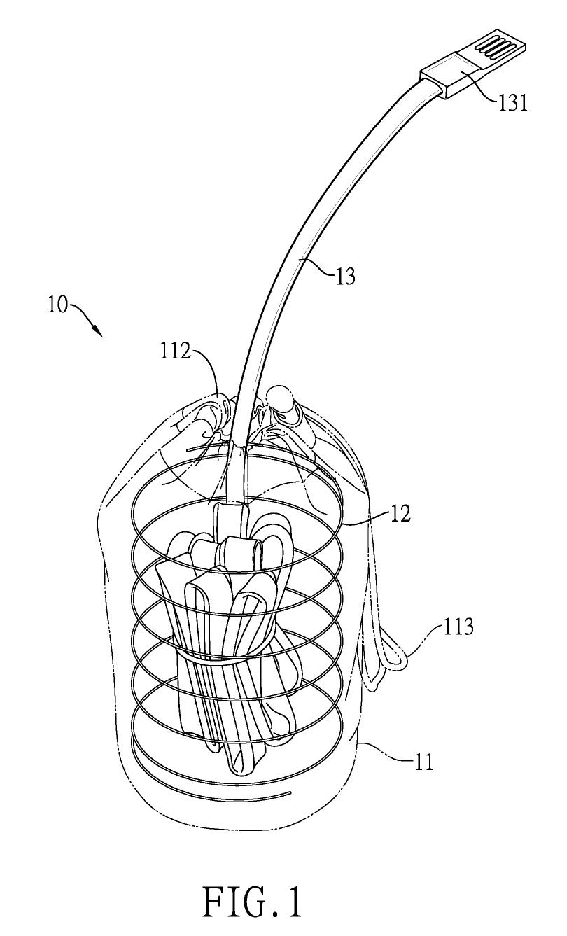

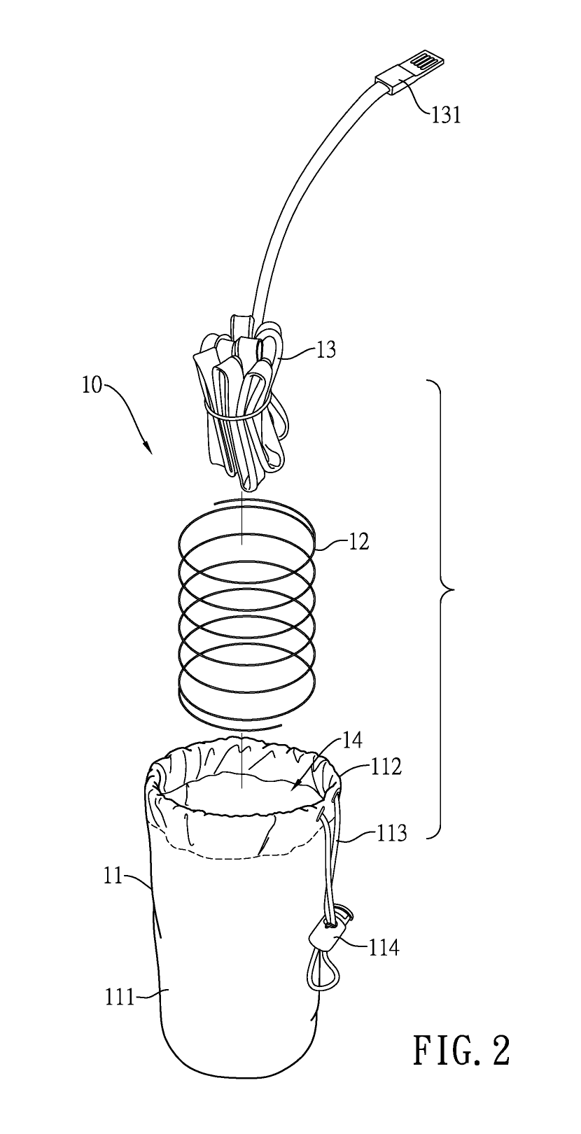

With reference to FIGS. 1 and 2, a lamp 10 in accordance with the present invention includes a lamp shade 11, a support frame 12 and a light strip 13.

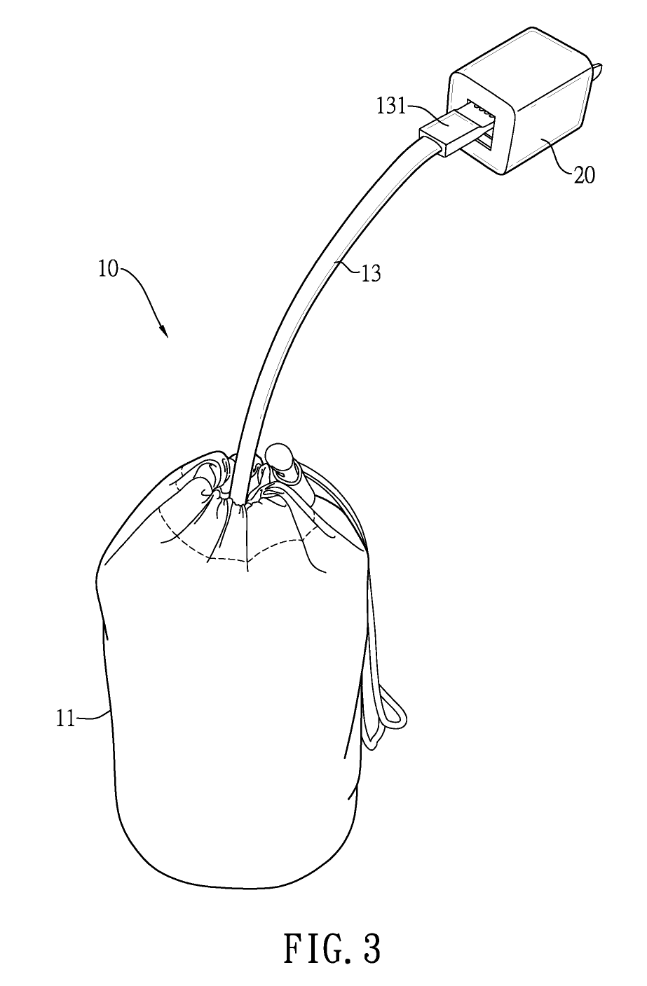

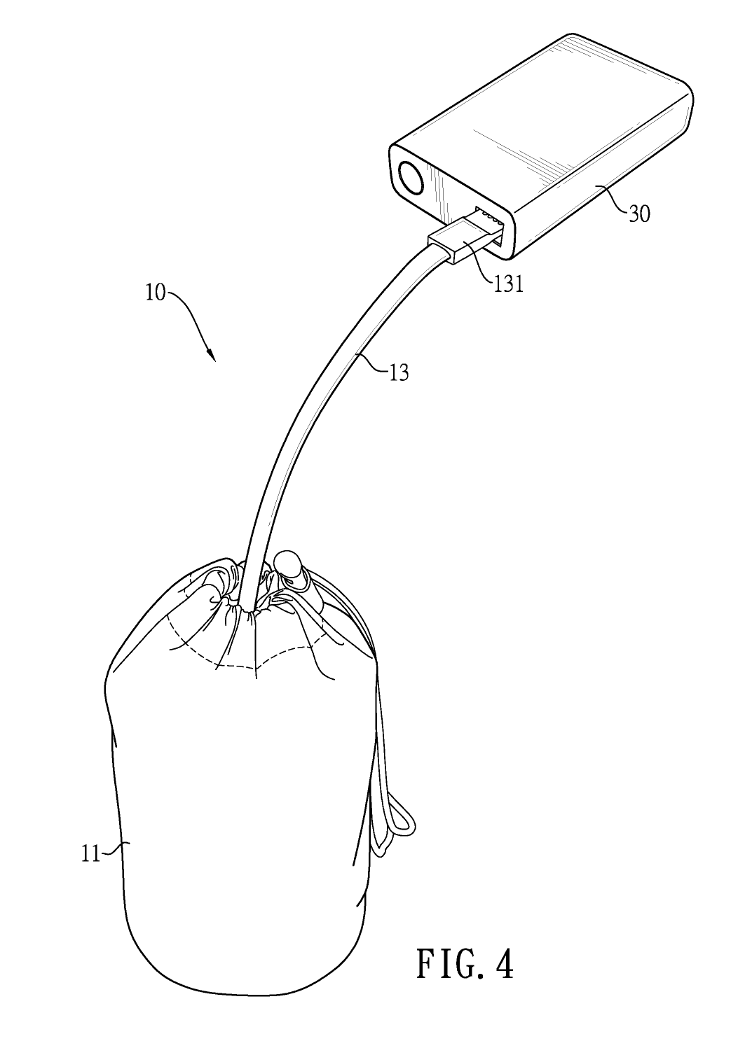

With reference to FIGS. 3 and 4, the lamp shade is made of a piece of transparent fabric, such as nylon fabric. The support frame 12 is made of a coiled steel wire, and is mounted inside the lamp shade 11 to prop and expand the lamp shade 11 to define an accommodation space 14 within the lamp shade 11. Preferably, the light strip 13 is a light-emitting diode (LED) light strip, which is mounted inside the accommodation space 14 and is located within the support frame 12. The light strip 13 has a power connection terminal 131 formed on one end of the light strip 13 and electrically connected to an external power source. The external power source may be a mains power. The power connection terminal 131 may be connected to a transformer 20 and further to the mains power. Alternatively, the external power source is a mobile power pack 30. As the mobile power pack 30 has advantages of being compact in size and light in weight, the lamp 10 collaborated with the mobile power pack 30 can be used at anywhere requiring lighting.

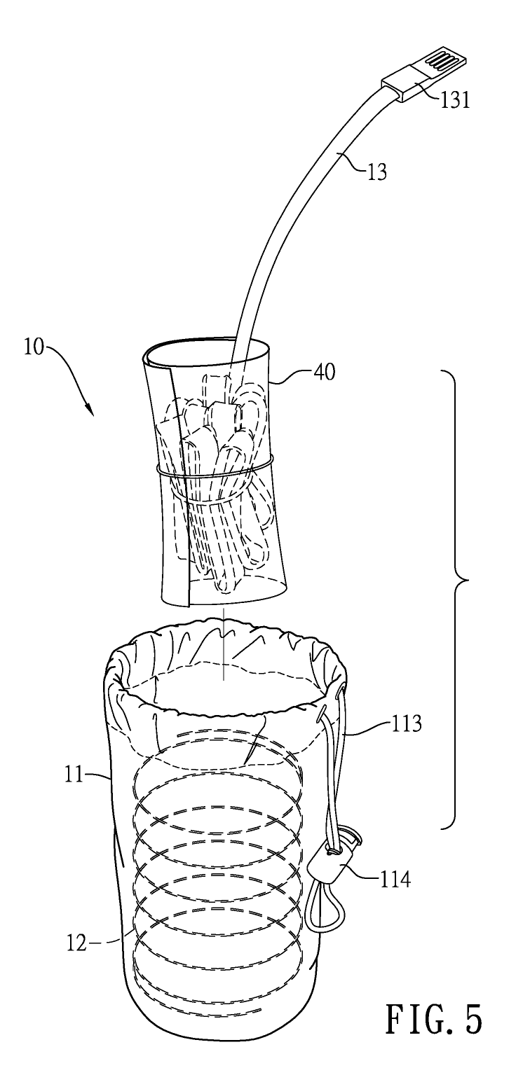

With reference to FIG. 5, under the circumstance of colored lighting provided by the lamp 10, the light strip 13 is wrapped around by a colored and transparent paper 40. The color of the transparent paper 40 can be chosen depending on user's preference for light generated by the light strip 13 to pass through the transparent paper 40 and to become light with the selected color, such that the lamp 10 can provide lighting with different colors. In different embodiments, the light strip 13 may be chosen to have LEDs thereon emitting red or blue light for the lamp 10 to provide lighting with different colors.

Furthermore, the lamp shade 11 may take the form a pull string bag and has a body 111, an opening 112, a pull string 113, and a retainer 114. The body 111 has an open end. The accommodation space 14 is defined inside the body 111. The opening 112 is formed around a rim of the open end of the body 11 and communicates with the accommodation space 14. The pull string 113 takes the form of a string in a loop, and penetrates an edge portion of the open end of the body 11 adjacent to the opening 112 with a part of the pull string 113 retained inside the edge portion and a remaining part of the pull string 113 exposed. The retainer 114 is movably attached to the pull string 113 to adjust a size of the opening 112.

After the retainer 114 is moved to a position on the pull string 113 distal to the opening 112 to expand the opening 112, the light strip 13 can be conveniently placed inside or removed from the lamp shade 11. After the retainer 114 is moved to a position on the pull string 113 proximal to the opening 112 to shrink the opening 114, the power connection terminal 131 of the light strip 13 can be stretched out for connection with the external power source. As for storage of the lamp 10, the light strip 13 and the power connection terminal 131 can be completely received in the lamp shade 11, and the retainer 114 is moved along the pull string 113 to close the opening 112 to facilitate storage of the lamp 10.

In sum, the lamp 10 in accordance with the present invention utilizes the light strip 13 which is constituted by LED as known for low power consumption, and can be placed at anywhere to provide lighting in collaboration with the use of the mobile power pack 30.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A lamp comprising:
a lamp shade having:
a body having an open end;
an accommodation space defined inside the body;
an opening formed around a rim of the open end of the body and communicating with the accommodation space;
a pull string penetrating an edge portion of the open end of the body adjacent to the opening with a part of the pull string retained inside the edge portion and a remaining part of the pull string exposed; and
a retainer mounted through by the pull string and movably attached to the pull string to adjust a size of the opening;
a support frame mounted inside the body of the lamp shade to prop and expand the lamp shade to define the accommodation space within the body of the lamp shade; and
a light strip mounted inside the accommodation space of the lamp shade, located within the support frame, and having a power connection terminal formed on one end of the light strip and electrically connected to an external power source.

2. The lamp as claimed in claim 1, wherein the lamp shade is made of a piece of transparent fabric.

3. The lamp as claimed in claim 1, wherein the external power source is a mobile power pack.

4. The lamp as claimed in claim 1, wherein the power connection terminal is connected to the external power source through a transformer.

5. The lamp as claimed in claim 1, wherein the support frame is made of a coiled steel wire.

6. The lamp as claimed in claim 1, further comprising a transparent paper wrapping around the light strip.

7. The lamp as claimed in claim 1, wherein the lamp shade takes the form a pull string bag.

8. The lamp as claimed in claim 1, wherein the light strip is a light-emitting diode (LED) light strip.
